(19) United States
(12) Patent Application Publication
(10) Pub. No.: US 2012/0236209 A1
(43) Pub. Date: Sep. 20, 2012

(54) SMART REMOTE CONTROL DEVICE WITH TEXT EDITING AND BATCH TRANSMITTING FUNCTIONALITY

(76) Inventor: Ke Wang, Chandler, AZ (US)

(21) Appl. No.: 13/047,749

(22) Filed: Mar. 14, 2011

(51) Int. Cl. H04N 5/44; G06F 15/16; G05B 15/02

(52) U.S. Cl. 348/734; 700/17; 709/206; 348/E05.096

(57) ABSTRACT

A smart remote control device is disclosed having local text editing functionality. User can use the smart remote control device to input and edit text and URL address using the local mini keyboard and display device; the smart remote control device can send the edited text in batch. The particular applications of this smart remote control device include smart TV and media center computers.

### FIELD

The present disclosure relates to remote control device that integrates local text editing function and can transmit the edited text in batch mode. The particular applications include smart TV and media center computers.

### BACKGROUND

Modern TV and media center PC usually come with remote control device that can transmit user key stroke on the remote control device to the TV or computer remotely. The remote control device is designed in such a way that each key stroke is treated as an independent command. With the development of the internet enabled smart TV and media center PC, there is increasing needs for user to input long text for content search, or URL address for web surfing. In order to use the remote control device to input the long text, user has to look down at the remote control device when striking a key and then look up at the screen to check the inputted text repeatedly. This operation requires user to constantly change focus of eyesight and body gesture, which makes the operation uncomfortable.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a top view of the smart remote control device.

FIG. 2 is a diagrammatic view of the flow chart of the smart remote control device.

### DETAILED DESCRIPTION

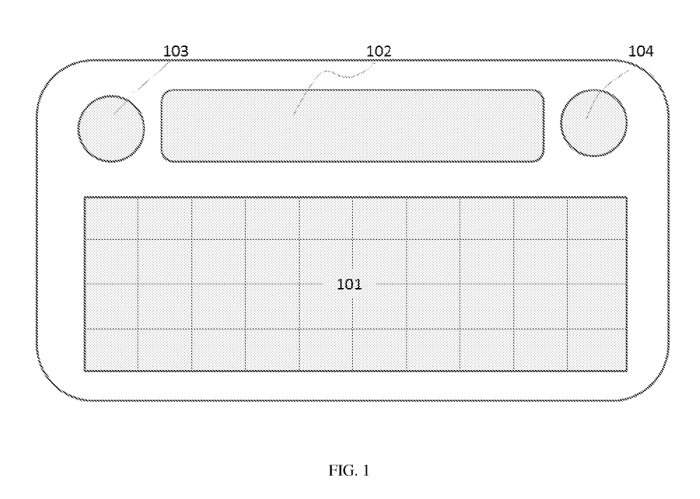

Referring to FIG. 1, the smart remote control device includes a mini keyboard 101, a display device 102 for text editing, a mode button or switch 103 to switch between local text editing mode and regular non-text editing mode, and a batch transmitting button 104 to transmit edited text. The smart remote control device may or may not include a pointing tracking device. The smart remote control device may have an indication device to let the user know if it is under local text editing mode or regular non-text editing mode.

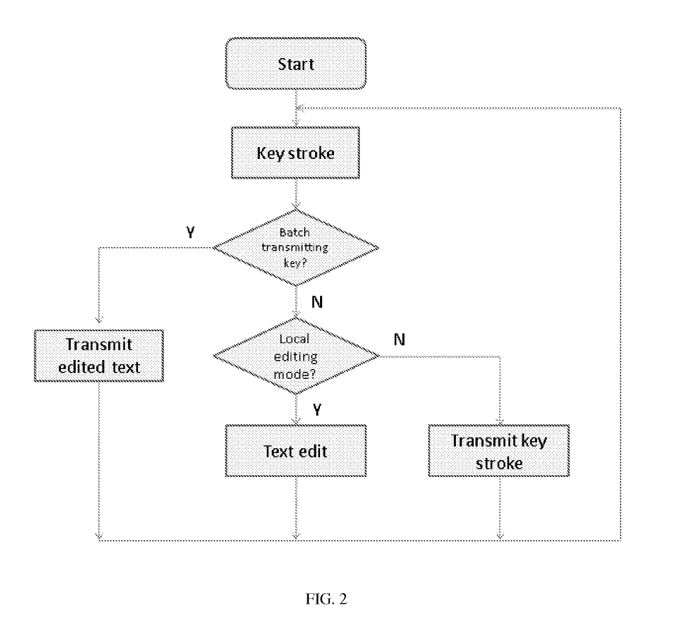

In local text editing mode, user uses the mini key board to input and modify the text input. The smart remote control device has internal memory to buffer the user inputted text. Once user finishes the text input and strikes the batch transmitting button, the text in the memory buffer will be transmitted one character by one character automatically. In the non-text editing mode, any user key stroke on the smart remote control device is transmitted immediately. The flow chart of the smart remote control device is shown in FIG. 2.

What is claimed is:

1. A remote control device including local text editing functions, said local text editing functions including
a mini keyboard for information input;
a display device to display text being edited;
a mode switch device to switch between local text editing mode and non-text editing mode;
a batch transmitting button to transmit edited text;
a memory device to buffer the locally inputted text.

2. The remote control device of claim 1, wherein said mini keyboard comprises mechanical or electrical interface for user to input and edit alphabetical characters, numerical characters, and special characters.

3. The remote control device of claim 1, wherein said a mode switch device can be a position switch or a push button.

4. The remote control device of claim 1, wherein said a batch transmitting button to transmit edited text one character by one character automatically.

5. A smart TV system compromising:
A remote control device including local text editing functions, said local text editing functions including
a mini keyboard for information input;
a display device to display text being edited;
a mode switch device to switch between local text editing mode and non-text editing mode;
a batch transmitting button to transmit edited text;
a memory device to buffer the locally inputted text.

6. The remote control device of claim 5, wherein said mini keyboard comprises mechanical or electrical interface for user to input and edit alphabetical characters, numerical characters, and special characters.

7. The remote control device of claim 5, wherein said a mode switch device can be a position switch or a push button.

8. The remote control device of claim 5, wherein said a batch transmitting button to transmit edited text one character by one character automatically.

9. A computer system compromising:
A remote control device including local text editing functions, said local text editing functions including
a mini keyboard for information input;
a display device to display text being edited;
a mode switch device to switch between local text editing mode and non-text editing mode;
a batch transmitting button to transmit edited text;
a memory device to buffer the locally inputted text.

10. The remote control device of claim 9, wherein said mini keyboard comprises mechanical or electrical interface for user to input and edit alphabetical characters, numerical characters, and special characters.

11. The remote control device of claim 9, wherein said a mode switch device can be a position switch or a push button.

12. The remote control device of claim 9, wherein said a batch transmitting button to transmit edited text one character by one character automatically.
